(19) United States
(12) Patent Application Publication
(10) Pub. No.: US 2011/0072388 A1
(43) Pub. Date: Mar. 24, 2011

(54) Method and Apparatus for Altering the Presentation Data Based Upon Displacement and Duration of Contact

(76) Inventors: Thomas Merrell, Beach Park, IL (US); Emily Schaeffer, Round Lake, IL (US); Murthy Pullela, Gurnee, IL (US); Hoi Young, Lake Villa, IL (US)

(21) Appl. No.: 12/565,101

(22) Filed: Sep. 23, 2009

(51) Int. Cl. G06F 3/048

(52) U.S. Cl. 715/784; 715/788

(57) ABSTRACT

A method (300) and apparatus (900) for altering the presentation of data (102) on a user interface such as a touch sensitive display (101) of an electronic device (100) are described. Alteration of the presentation of data (102) can include scrolling, paging, and so forth. Scrolling velocity can be selected based upon predetermined velocity data (108) stored in a memory (105). Velocity selection can be dependent upon displacement (109) of a user's finger (110) or stylus along a user interface. Deceleration of the data presentation alteration can be based upon contact duration and the velocity at which the data presentation is being altered when the user's finger (110) or stylus breaks contact with the user interface, as determined from predetermined deceleration data or overshoot curves (113,114,115) stored in memory (105).

### BACKGROUND

1. Technical Field

This invention relates generally to user input interfaces and associated methods for electronic devices, and more specifically to a method and apparatus for scrolling data or altering the presentation of data on a display in response to displacement and temporal inputs from a user.

2. Background Art

Portable electronic devices, such as mobile telephones, media devices, gaming devices, and personal digital assistants, are becoming increasingly sophisticated. Such mobile communication devices are becoming, more and more, an integral part of the business and personal lives of their users. Advances in memory capacity have led to mobile communication devices that can store hundreds of thousands of data elements. By way of example, some portable electronic devices like phones and multimedia players are capable of storing hundreds of music and video files. Similarly, the contents of an entire business card file can easily be stored as an address book list in many mobile telephones. These address book lists are capable of easily storing hundreds or even thousands of entries. An address book may also contain many entries of the same name, particularly where a certain name is a common name.

One problem associated with all of this data is accessing a particular record in the data. Another problem involves manipulating the presentation of data as a list on the display. Many portable electronic devices today are small, handheld units. As such, the space on the device for displays is limited. While a particular device may be capable of storing thousands of addresses, it may be capable of presenting only ten to fifteen on the display at any one given time. While users are often permitted to scroll through the list, when there are hundreds of entries, scrolling through so many entries may be cumbersome and time consuming. This is often the case because the goal of being able to quickly move through a list of data conflicts with the goal of being able to accurately scroll through a list. With prior art scrolling techniques, one must generally scroll slowly to be accurate, as fast scrolling is generally an inaccurate process. However, when navigating through large amounts of data, a user generally desires to scroll both quickly and accurately.

There is thus a need for an improved method and apparatus that enables both quick and accurate scrolling or other manipulation of the presentation of data in an electronic device.

### BRIEF DESCRIPTION OF THE DRAWINGS

FIG. 1 illustrates one portable electronic device configured for altering the presentation of data in accordance with embodiments of the invention.

FIG. 2 illustrates a general method of altering the presentation of data on the display of an electronic device in accordance with embodiments of the invention.

FIG. 3 illustrates a more detailed method of altering the presentation of data on the display of an electronic device in accordance with embodiments of the invention.

FIG. 4 illustrates one method of transitioning from a continuous scroll presentation to a discrete step presentation in accordance with embodiments of the invention.

FIG. 5 illustrates one illustrative velocity curve in accordance with embodiments of the invention.

FIGS. 6-8 illustrate exemplary deceleration or overshoot curves in accordance with embodiments of the invention.

FIG. 9 illustrates one circuit for altering the presentation of data on a display in accordance with embodiments of the invention.

FIG. 10 illustrates one embodiment of a user interface in accordance with embodiments of the invention.

FIG. 11 illustrates one portable electronic device configured for altering the presentation of data in accordance with embodiments of the invention.

FIG. 12 illustrates a portable electronic device without a touch sensitive display configured for altering the presentation of data in accordance with embodiments of the invention.

FIG. 13 illustrates an electronic device without a touch sensitive display configured for altering the presentation of data in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to scrolling or otherwise altering the presentation of data on a display. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of scrolling or otherwise altering the presentation of data as described herein. The non-processor circuits may include, but are not limited to, a radio receiver, a radio transmitter, signal drivers, clock circuits, power source circuits, and user input devices. As such, these functions may be interpreted as steps of a method to perform the scrolling or data presentation alteration. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide methods and apparatuses for altering the presentation of data, such as when scrolling through a list of data, that is both displacement based and temporally based. The embodiments described herein are displacement based in that the velocity with which the data presentation changes, e.g., the rate at which the data scrolls across a display, is dependent upon the displacement of an object across a user interface. For example, if the user interface is a touch sensitive display, a user initially contacts the touch sensitive display at point A. The user then moves their finger or stylus to point B, which is some displacement amount away from point A. Similarly, where the user interface is a joystick, a user initially contacts the joystick in the neutral position. The user then deflects the joystick to point B, which is some displacement amount away from the neutral position. In accordance with one embodiment, the velocity at which the data presentation changes is based upon this displacement determination—the further away from point A the user's finger is, or the further the joystick is from the neutral position, the faster data scrolls.

Embodiments are temporal in that the mechanism for controlling the cessation of the alteration of the presentation of data is based, in part, on the amount of time the user has a finger, stylus, or other object in contact with the user interface. Alternatively, where the user interface is not touch sensitive, as is the case when the user interface is a joystick or mouse, the cessation can be based upon the amount of time that the joystick or mouse is actively actuated by the user.

In one embodiment, the cessation of alteration is based upon both the velocity of alteration when the object is no longer in contact with the user interface and the duration during which the object was in contact with the user interface. For example, a number of data elements to “overshoot” once the object breaks contact with the user interface can be selected from data stored on memory based upon the contact duration and the velocity of alteration when the object broke contact. This will become clearer with the description of the various figures below.

Where the alteration of the presentation is a scrolling process through a list, grid, or graphic presentation of data elements, in one embodiment the scrolling process is dependent upon both displacement and a deceleration factor that is determined when the user's finger or stylus is removed from the user interface in a touch-sensitive configuration. In a non-touch sensitive configuration, the scrolling process is dependent upon both displacement and a deceleration factor that is determined when the mouse, joystick, or other device is deactuated. In one embodiment, the velocity is determined by mapping a given deflection to a predefined velocity curve that is stored in memory. The points on the curve specify an instantaneous velocity at which the data will scroll.

For example, in one embodiment the velocity curve may represent a number of data elements to scroll per second versus each millimeter of displacement. When using a touch sensitive interface and a user's finger or stylus has traversed the user interface by, say, four millimeters, the data elements may start scrolling at a rate of four elements per second, and so forth. This is but one illustrative embodiment, as it will be clear to those of ordinary skill in the art having the benefit of this disclosure that other curves can be applied as well. Linear curves, non-linear curves, or other curves may be used based upon application, thereby allowing for many different user experiences during the scrolling process. Further, while scrolling is used as one illustrative embodiment of data presentation alteration, it will be clear to those of ordinary skill in the art having the benefit of this disclosure that scrolling is but one type of data presentation alteration. Methods and apparatuses described herein are applicable to other types of alteration, including magnification adjustments, sorting, and so forth.

Embodiments of the invention provide a user with a convenient and simple way of adjusting the presentation of data on a display. For instance, using the scroll device and associated methods of the invention, a user may scroll through long lists of data quickly and accurately. Embodiments of the invention facilitate quick convergence on a particular record. Alternatively, the user may adjust the magnification associated with an image stored in memory.

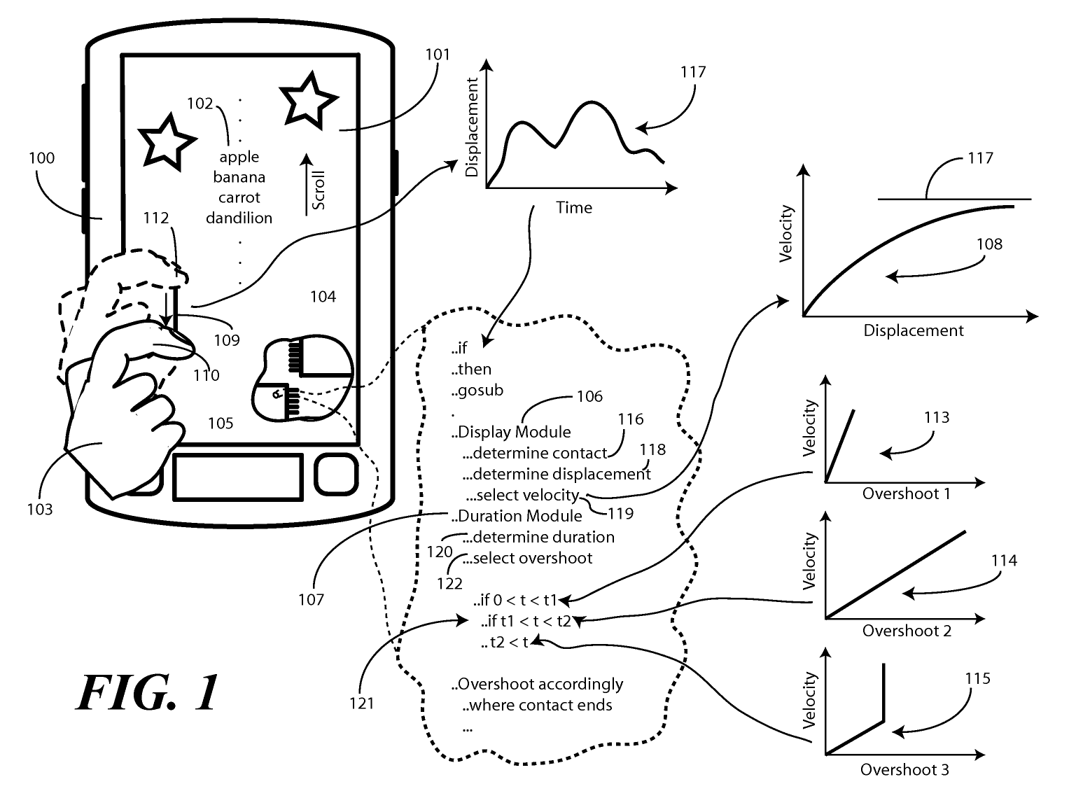

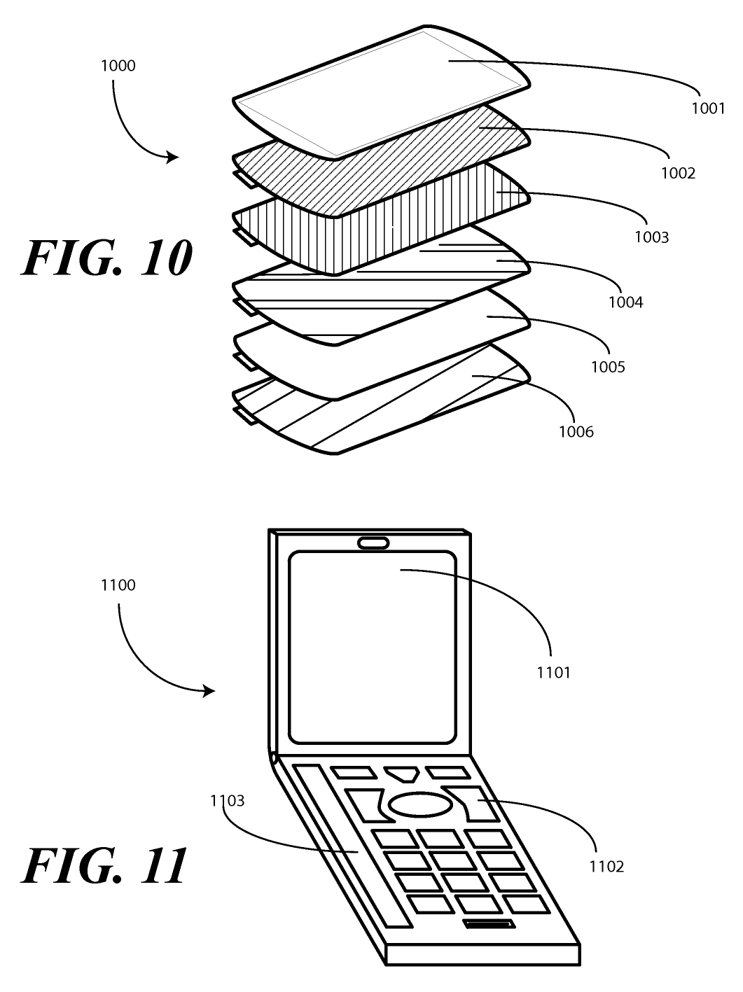

Turning now to FIG. 1, illustrated therein is a portable electronic device 100 having a display and a user interface. In the illustrative embodiment of FIG. 1, the display and user interface are integrated together as a touch sensitive display 101. Touch sensitive displays are well known in the art. Further, one example of a touch sensitive display 101 suitable for use with embodiments of the invention is shown and described below in FIG. 10.

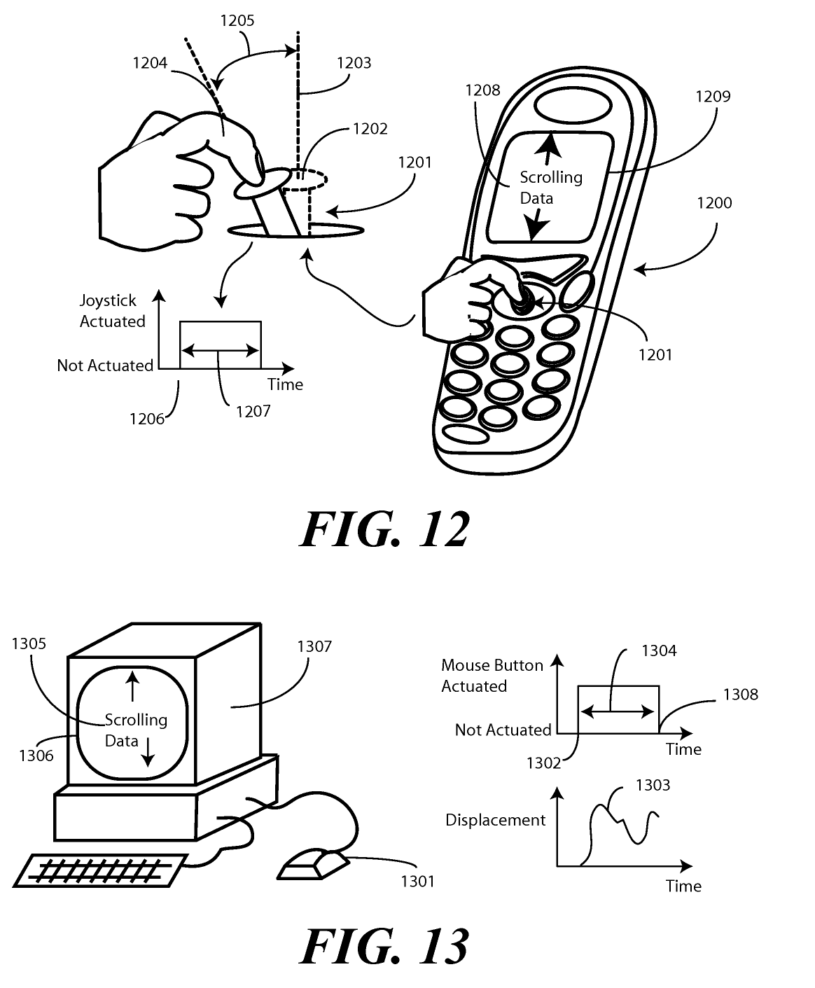

While a touch sensitive display 101 combining a user input interface and display suitable for use with embodiments of the invention, it will be clear to those of ordinary skill in the art having the benefit of this disclosure that the invention is not so limited. For example, an electronic device having a separate user interface and display is shown below in FIGS. 11 and 12. In addition to touch sensitive user interfaces, non-touch sensitive user interfaces including a mouse, joystick, optical mouse, or other device can also be used in accordance with embodiments of the invention. Further, while the exemplary electronic device 100 shown in FIG. 1 is a mobile telephone, it will be clear that methods and apparatuses described herein are also applicable to other electronic devices, including gaming devices, multimedia players, personal digital assistants, portable computers, and the like.

In the illustrative embodiment of FIG. 1, the touch sensitive display 101 is configured both to receive input from a user 103 and to present data 102, files, images, or other information to a user. In one embodiment, the input is tactile input, such as that received when a user touches a finger or stylus to the touch sensitive display 101. Examples of data 102 include lists of data elements, thumbnails of images stored in memory, icons representing videos stored in memory, and so forth. This exemplary data is not exclusive, as other types of data may be presented as well. Examples of lists of elements comprising the data 102 include addresses, telephone numbers, songs, videos, and so forth. Embodiments of the invention are suited for sorting through this data 102 when too many data elements exist to be presented on the touch sensitive display 101 at one time.

A control circuit 104, which may be a microcontroller, a microprocessor, ASIC, logic chip, or other device, serves as the brain of the electronic device 100. The control circuit 104 can include other processing units dedicated to performance of specific functions. For example, an integrated or stand-alone digital signal processor may handle the processing of incoming communication signals or data. In the illustrative embodiment of FIG. 1, the control circuit 104 is illustrated for simplicity as an integrated circuit, but shall be understood to be representative of any processing architecture known to those skilled in the art.

The control circuit 104, which can be a single processor, such as a microprocessor integrated circuit, or alternatively may comprise one or more processing units or components, is coupled to the memory 105 or other computer readable medium. By executing operable code stored in the memory 105, the control circuit 104 performs the various functions of the device.

In one embodiment, the control circuit 104 executes code comprising one or more routines stored either in the memory 105, which may comprise one or more memories. The memory 105 may comprise a separate and distinct integrated circuit connected and operable with the control circuit via a data bus. The memory 105 may include one or more read-only memories, dynamic or static random-access memory, or any other type of programmable memory, such as one or more EPROMs, EEPROMs, registers, and the like. In some embodiments, the memory 105 can comprise non-traditional storage devices, such as a SIM, USIM, R-UIM, NVM, etc. The routines stored in the memory 105 can be stored in the form of executable software, firmware, or in any other fashion known to those skilled in the art.

In addition to the executable code operable with the control circuit 104, the memory 105 may further store other information. For instance, as will be described in more detail below, the memory 105 can include predetermined velocity data, such as one or more velocity curves. Additionally, the memory 105 can store predetermined deceleration data, such as one or more overshoot curves that will be used in ceasing the scrolling process in accordance with a deceleration momentum that specifies within how many data elements the system will to come to a stop.

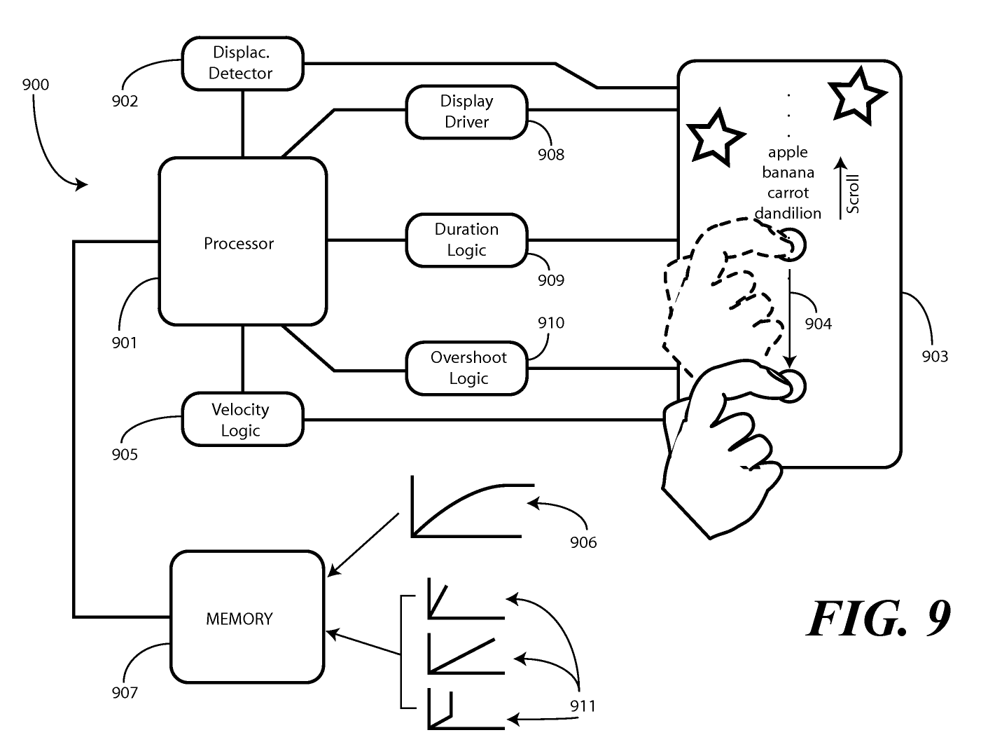

The executable code stored within the memory 105 can be configured as modules. Alternatively, as will be shown in FIG. 9 below, the various modules can be configured as logic in hardware as well. In one embodiment, these modules include a displacement module 106 and a duration module 107. The displacement module 106 is used to determine a velocity at which the electronic device 100 will alter the presentation of data, while the duration module 107 can be used to determine how the electronic device 100 will stop the scrolling process.

Generally, embodiments of the present invention alter the presentation of data 102 by causing the data 102 to scroll along the touch sensitive display in accordance with a velocity determined from a velocity curve 108, stored in memory 105, based upon a displacement 109 traversed by an object, such as the user's finger 110, along the touch sensitive display 101. As such, the farther the user 103 moves the finger 110 from an initial contact position 112, the data 102 scrolls faster. In the illustrative velocity curve 108 of FIG. 1, a maximum velocity is set by asymptote 117. As will be described in FIG. 4, in one embodiment once the maximum velocity is reached, the scrolling process may optionally transition from a continuous scrolling process to a discrete step process.

Once the user's finger 110 is removed from the touch sensitive display 101, the scrolling process stops. In one embodiment, it is stopped based upon two factors—the amount of time the finger 110 was in contact with the user interface and the velocity at which the data 102 was scrolling when the finger 110 was removed from the user interface. Said differently, in one embodiment the scrolling is stopped based upon the amount of time the finger 110 was in contact with the user interface and the displacement 109 detected when the finger 110 was removed from the user interface.

In one embodiment, the scrolling is stopped in accordance with an “overshoot factor” that is determined from one or more overshoot curves 113,114,115 stored in the memory 105. The overshoot factor is a number of elements that are to be scrolled through once the user's finger 110 is removed from the touch sensitive display 101. These data elements may be scrolled through in accordance with a predetermined deceleration curve also stored in memory 105.

In one embodiment, the one or more overshoot curves 113,114,115 include a plurality of curves based upon the time that the user's finger 110 was in contact with the touch sensitive display 101. For example, if the time was within a first interval, such as less than a first predetermined duration, a first overshoot curve 113 may be used. One example of the first predetermined duration might be one-half of a second. Similarly, where the time was more than the first predetermined duration, but less than a second predetermined duration, a second overshoot curve 114 may be used to determine the overshoot factor. An example of a second predetermined duration might be one second.

Where a third overshoot curve 115 is stored in the memory 105, the third overshoot curve 115 may correspond to the user's finger 110 being in contact with the touch sensitive display 101 for more than the second predetermined duration. Where this is the case, the overshoot factor may be selected from the third overshoot curve 115. It will be clear to those of ordinary skill in the art having the benefit of this disclosure that the invention is not limited to three overshoot curves, as any number of overshoot curves could be used depending upon the amount of granularity in resolution desired in a particular application. Similarly, multiple velocity curves could be used as well.

Note also that both the velocity curve and the overshoot curves can be represented as any number of functions. For example, in the illustrative embodiment of FIG. 1, the velocity curve 108 is a non-linear curve, as is the third deceleration curve 115. The other two exemplary overshoot curves 113,114 are shown as being linear.

In one embodiment, the control circuit 104 is coupled to the touch sensitive display 101 and is configured with operable code to detect 116 user contact with the touch sensitive display 101. For example, a user 103 may place his finger 110, a stylus, or other object on the touch sensitive display 101 at an initial contact point 112. As will be shown in FIG. 10 below, this contact can be detected with the assistance of a capacitive sensor layer or other touch sensitive technology known in the art. The control circuit 104 then monitors this contact as the user 103 moves the finger 110, stylus, or other object to determine 118 a displacement 109 traversed by the user's finger 110, stylus, or other object. Concurrently, the control circuit 104 monitors the duration during which the finger 110, stylus, or other object is in contact with the touch sensitive display 101. This can be accomplished, for example, by initiating a timer when the user 103 makes initial contact. An illustrative plot of one displacement versus time is shown at 117.

Once the displacement 109 is determined, in one embodiment the control circuit 104 retrieves predetermined velocity data from the memory 105. In FIG. 1, the predetermined velocity data is shown as the velocity curve 108, which is a plot of velocity versus displacement. From this velocity curve 108 and the known displacement 109, the control circuit 104 can select 119 a velocity that corresponds to the displacement 109. The control circuit 104 then causes the data 102 to scroll in accordance with the selected velocity.

The scrolling continues until the user's finger 110, stylus, or other object is lifted from the touch sensitive display 101. At this time, the control circuit 104 determined 120 the duration during which the finger 110, stylus, or other object was in contact with the touch sensitive display 101. In one embodiment, the control circuit 104 will determine within which predetermined duration range 121 the duration was, and will select one overshoot curve from a plurality of overshoot curves 113,114,115. In one embodiment, each overshoot curve 113,114,115 is a plot of velocity versus a number of data elements to overshoot. It will be clear that each overshoot curve 113,114,115 could also be a plot of displacement versus number of data elements to overshoot.

From the selected velocity curve, the control circuit 104 selects 122 an amount of overshoot. The control circuit 104 then ceases the scrolling process in accordance with the selected amount of overshoot.

Illustrating by way of example, consider where a user makes a quick “flick” of their finger, such as a swipe of ten millimeters across the touch sensitive display 101. The contact duration is short while the displacement is large. This action results in a relatively high scrolling velocity. However, using illustrative overshoot curve 113, only a few data elements will be overshot. Now consider where the user moves his finger 110 ten millimeters and holds the finger 110 there for thirty seconds. The velocity will be the same as the flick. However, using illustrative overshoot curve 115, the number of data elements overshot will be higher than with the flick. As the finger 110 is in contact with the touch sensitive display 101 for a longer period of time, the user 103 intuitively expects more items to be overshot. The embodiment of FIG. 1 delivers this expectation to the user 103. The consideration of both displacement 109 and duration provides a scrolling system with an intuitive feel for the user 103. The embodiment of FIG. 1 offers advantages over prior art systems in that it provides immediate responsiveness with no lag while the finger 110 is touching the user interface, but still a natural, dampened deceleration when the finger 110 is lifted from the user interface.

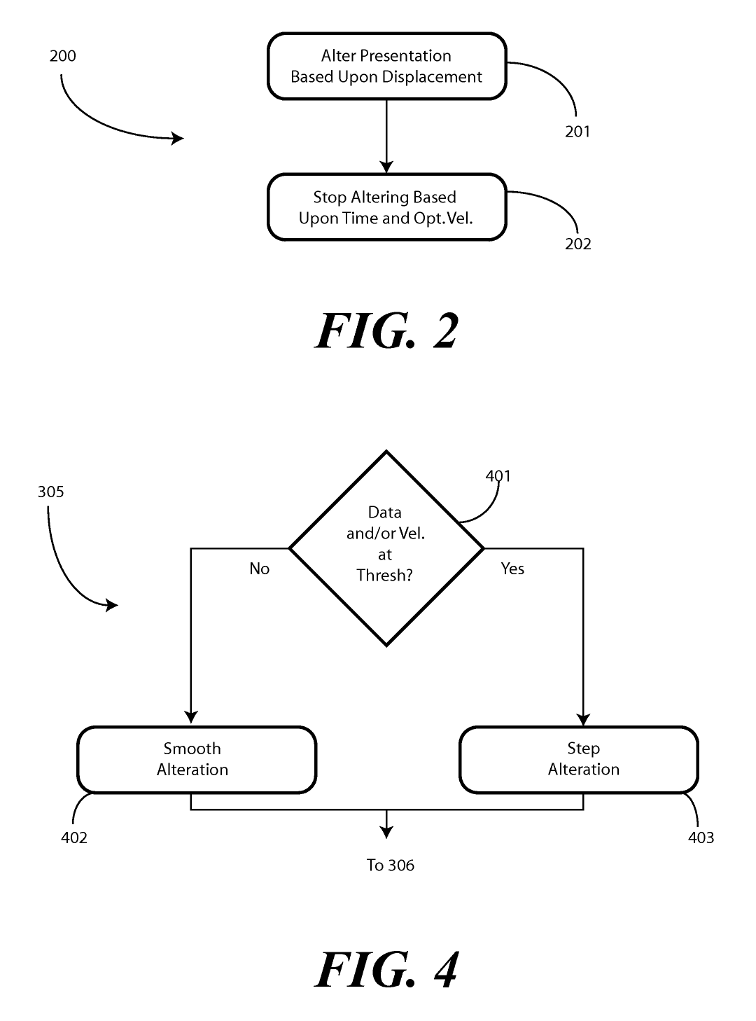

Turning now to FIG. 2, illustrated therein is an exemplary method 200 for altering the presentation of data on a display shown as a general flow chart. The method 200 follows generally the steps occurring in FIG. 1. At step 201, the presentation of data on the display of an electronic device is altered. The alteration may comprise scrolling through a list, paging through icons, files, or a grid, or other forms of sorting through data elements. The alteration occurs in accordance with a velocity that is selected from predetermined velocity data stored in a computer readable medium. As described above, the velocity is dependent upon a displacement traversed by an object along a user interface. Note that the velocity selected at this step can change as the object moves along the user interface. In one embodiment, the velocity will continuously change in accordance with the predetermined velocity data until contact between the object and user interface is broken.

Where the display is touch sensitive, the user interface and display may be integrated into a single device. In other electronic devices, the display and user interface will be separate elements.

At step 202, the alteration is terminated in accordance with a deceleration factor that is selected from predetermined deceleration data stored in the computer readable medium. The deceleration factor can be based upon a single factor, such as a duration during which the object is in contact with the user interface. Alternatively, the deceleration factor can be based upon multiple factors. As noted above, in one embodiment the deceleration factor can be based upon both the contact duration and the velocity at which the data presentation alteration is occurring when contact with the user interface is broken.

In one embodiment, as described above, the deceleration factor can be an overshoot factor, such as a number of data elements to scroll through upon contact being broken with the user interface. It will be clear to those of ordinary skill in the art having the benefit of this disclosure that the invention is not so limited, however. For instance, in one embodiment the deceleration factor may simply be a measure of deceleration that is applied to the then occurring velocity such that the data presentation alteration ceases within a certain time. In another embodiment, the deceleration factor may be an amount of time during which the data presentation alteration should cease.

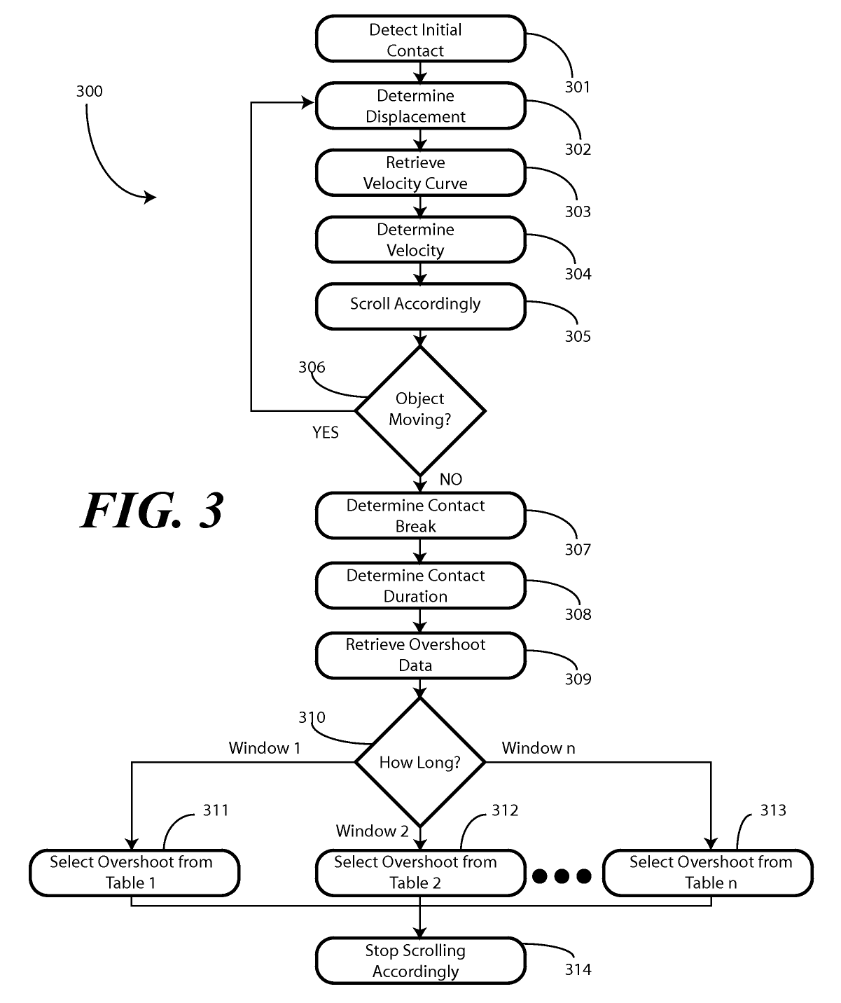

Turning now to FIG. 3, illustrated therein is a more detailed method 300 for altering the presentation of data on a display of an electronic device in accordance with embodiments of the invention. At step 301, contact with a user interface of the electronic device is detected. This detection can occur via a touch sensitive surface, such as a pad or series of controls configured to receive tactile input from a user. Alternatively, this detection can occur through a touch sensitive display as will be described in more detail in FIG. 10.

At step 302, an amount of displacement is determined between an initial contact position and a current contact position. In one embodiment, this displacement can be determined by recording the initial contact position determined at step 301 and then continually monitoring a current contact position at step 302. The distance between the two points may then be determined by subtracting coordinates of the two points to determine the displacement.

At step 303, predetermined velocity data is retrieved from a memory or other computer readable medium. One example of such predetermined velocity data will be described below with reference to FIG. 5. Other examples of predetermined velocity data will be obvious to those of ordinary skill in the art having the benefit of this disclosure.

At step 304 the velocity is determined by mapping the displacement determined at step 302 to the predetermined velocity data retrieved at step 303. At step 305, the data presentation is altered in accordance with the velocity selected at step 304. In one embodiment, the alteration of the data comprises scrolling through a list of data elements.

At step 306, it is determined whether the object contacting the user interface is still in contact with the user interface and, if so, whether it is moving. Where the object is moving, the velocity can be continually updated by repeating steps 302,303,304, and 305. This updating permits the user to change the rate at which data is presented across the display simply by moving the object contacting the user interface to a new position.

At step 307, cessation of contact between the object and the user interface is detected. Where, for example, the user interface is a touch sensitive display, this step 307 can be accomplished by failing to receive a signal from a capacitive or other type of touch sensor that the object is still in contact with the user interface. At step 308, the amount of time during which the object contacting the user interface has been in contact with the user interface is determined. This is done, in one embodiment, by initiating a timer at step 301 and then reading the timer at step 308.

As noted above, in one embodiment the amount of deceleration or overshoot used to stop the data presentation alteration is based upon predetermined deceleration data. In the illustrative embodiment of FIG. 3, the predetermined deceleration data comprises a plurality of overshoot curves, with each overshoot curve being associated with a contact duration. The contact duration is compared to various thresholds at decision 310. Where, for example, the contact duration is less than a first predetermined duration, a first overshoot table will be selected at step 311. Where the contact duration is more than a first predetermined duration and less than a second predetermined duration, a second overshoot table will be selected at step 312. Where the contact duration exceeds the second predetermined duration, a third overshoot table will be selected at step 313. It will be clear to those of ordinary skill in the art having the benefit of this disclosure that one, two, three, four, or any number of overshoot tables can be used with embodiments of the invention, and the scope of embodiments of the invention is not to be limited to the three shown in FIG. 3.

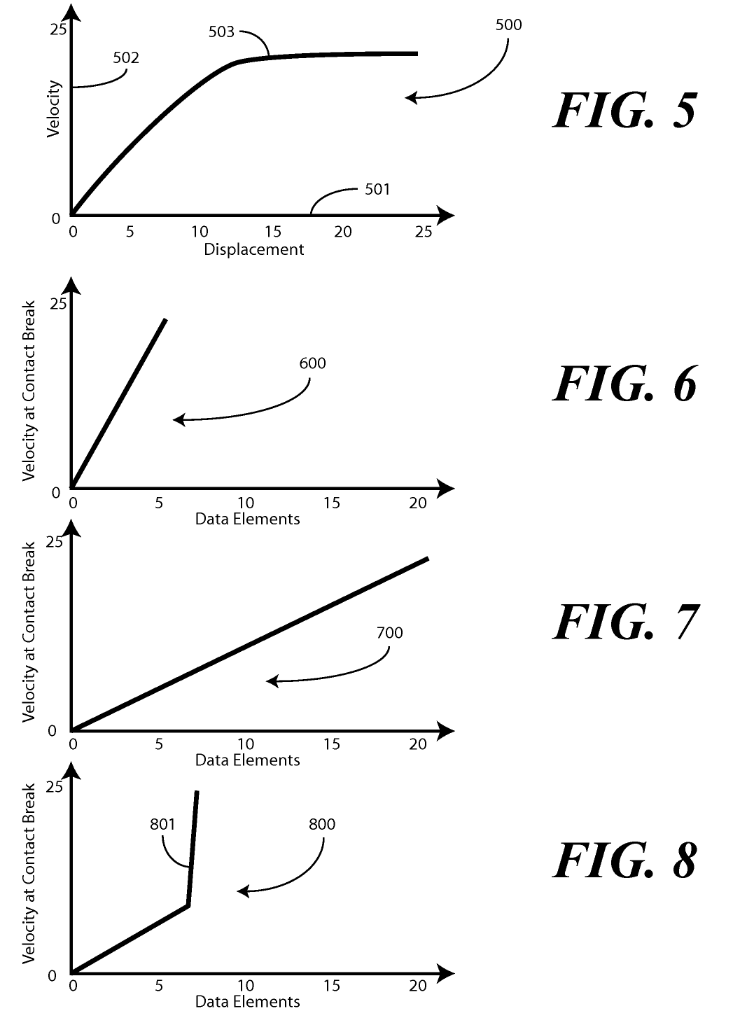

As will be shown in the discussion of FIGS. 6-8, the amount of overshoot can also be based upon velocity or another variable. Once the duration determination is made at decision 310 and the proper table selected at one of steps 311,312,313, the data presentation alteration is stopped at step 314 in accordance with the deceleration factor or overshoot amount.

Turning now to FIG. 4, illustrated therein is one alternate embodiment of step 305 from FIG. 3. There will be some applications in which so much data is stored within an electronic device that even when scrolling at the maximum scroll velocity set forth in the predetermined velocity data, it will take too long to reasonably scroll through a given list. In such situations, the method (300) can optionally choose to “step” through the list, such as stepping alphabetically or in accordance with another factor, rather than continuously scrolling.

Specifically, at decision 401, it is determined whether the maximum scroll velocity has been reached. At this step, the method (300) may also optionally consider the amount of data to be displayed to determine if it is above a predetermined threshold as well. The data threshold can be set based upon memory size, display size, and so forth. The maximum velocity can be set in the predetermined velocity data. Where the maximum velocity and/or the data threshold are not reached, the method (300) will scroll normally at step 402. Where the maximum velocity and/or the data threshold are reached, the method (300) can step through the data. By way of example, this stepping can be alphabetic, where it halts briefly at the beginning of each alphabetic section of a list in order. Alternatively, the steps may also jump to some other arbitrarily specified positions in the list. For instance, if the list is ordered by entry type, the type of record or file may be used as a stepping key. When, for example, the velocity drops below the maximum threshold, the scrolling may revert back to smooth scrolling at step 402.

Turning now to FIG. 5, illustrated therein is one exemplary velocity curve 500, which represents illustrative predetermined velocity data. In FIG. 5, the horizontal axis 501 represents displacement, while the vertical axis 502 represents velocity. By mapping the displacement detected along the user interface on the horizontal axis 501, a particular velocity can be determined.

The curve 503, representing velocity depending from displacement magnitude, comprises a plurality of predetermined velocities that each correspond to a displacement magnitude. In the illustrative embodiment of FIG. 5, the curve 503 is non-linear. Experimental testing has shown that this higher-order curve 503 provides an intuitive, user-pleasing velocity change in relation to displacement. It will be clear to those of ordinary skill in the art having the benefit of this disclosure that linear curves may be used as well. Additionally, while one curve 503 is shown in FIG. 5, multiple curves could be used, with the proper curve being selected based upon an amount of data to be displayed, for example, such that users with more data would have higher scrolling velocities than those with less data.

Turning now to FIGS. 6-8, illustrated therein are a plurality of overshoot curves 600,700,800. Each curve 600,700,800 represents a plurality of data element overshoot quantities versus velocity. For instance, in each curve 600,700,800 the horizontal axis represents a number of data elements to overshoot when terminating the scroll or other data presentation alteration process, while the vertical axis represents the velocity when contact between the object and the user interface is broken. By mapping a particular velocity along the vertical axis, a predetermined number of records to overshoot can be determined.

As described with FIG. 3, each overshoot curve 600,700,800 can be associated with a predetermined contact duration window. To illustrate by example, presume that overshoot curve 600 corresponds to contact durations of less than one-half second. Presume that overshoot curve 700 corresponds to contact durations of between one-half second and one second. Overshoot curve 800 then corresponds to contact durations exceeding one second. The proper curve can be selected by determining which contact duration window spans the determined contact duration.

As shown in FIGS. 6-8, the curves 600,700,800 can be linear or non-linear. For instance, curve 600 is linear and essentially runs from zero to two data elements to overshoot for every velocity. Thus, if a user briefly touches the user interface, only a few records will be overshot when stopping the scrolling process.

Curve 700 is also linear, and spans a much wider range of data elements to overshoot. Where the velocity is slow, for example, perhaps between five and eight data elements will be overshot when stopping the scrolling process. Where velocity is fast, however, perhaps as many as eighteen or twenty data elements will be overshot when stopping the scrolling process.

Curve 800 is non-linear. This is because a maximum overshoot value is represented by vertical element 801. Once the contact duration exceeds a predetermined limit, and velocity is sufficiently high, the amount of overshoot will be limited, in this illustrative embodiment, by the maximum overshoot value. Each of these curves is illustrative only, as embodiments of the invention provide the designer with the flexibility to design the ergonomics of a device in accordance with their own data.

Turning now to FIG. 9, illustrated therein is a circuit 900 for use in presentation of data on a display in an electronic device in accordance with embodiments of the invention. While the embodiment of FIG. 1 was shown as residing in executable instructions, embodiments of the invention can equally be configured in hardware, such as with programmable logic, application specific integrated circuits, and so forth.

A processor 901 can be configured with the various circuits integrated therein, or alternatively may coordinate data flow between the various circuit components. A displacement detector 902 is configured to determine a displacement 904 traversed by an object along a user interface 903. A velocity selector 905 then is configured to select a velocity with which to alter the presentation of data on a display from predetermined velocity data 906 stored in memory 907. The selected velocity is then used to control a display driver 908 to alter the presentation of data, such as by scrolling, stepping, paging, parsing, or otherwise, in accordance with the velocity.

A duration detector 909 is configured to determine a duration with which the object is in contact with the user interface 903. This can be done with the assistance of a timer that is initiated when contact is made. An overshoot selector 910 is then configured to select an overshoot quantity of data elements to display when the object ceases contact with the user interface 903. In one embodiment, this overshoot quantity is based upon the duration of contact and the velocity of data presentation alteration when contact stops. The overshoot selector 910 can determine the overshoot quantity from a plurality of overshoot curves 911 stored in the memory 907.

Turning now to FIG. 10, illustrated therein is an exploded view of one embodiment of an exemplary user interface 1000 for an electronic device in accordance with the invention. The exemplary user interface 1000 shown in FIG. 2 is that of a touch sensitive user interface, in that it is configured to receive tactile input from a user, such as by finger or stylus.

The user interface 1000 is touch sensitive in that a capacitive sensor layer 1002 detects the presence of a user's finger or stylus. As this capacitive sensor layer 1002 is a component of the user interface 1000, it may be used as a touch sensor for the purpose of altering the presentation of data as recited herein. Embodiments of similar user interfaces are described in greater detail in copending, commonly assigned U.S. application Ser. No. 11/684,454, entitled “Multimodal Adaptive User Interface for a Portable Electronic Device,” which is incorporated herein by reference. This user interface 1000 is illustrative only, in that it will be obvious to those of ordinary skill in the art having the benefit of this disclosure that any number of various user interfaces could be substituted and used in conjunction with the data presentation alteration methods described herein.

Starting with the top layer of this exemplary user interface 1000, a cover layer 1001 serves as a protective surface. The cover layer 1001, in one embodiment, is a thin film sheet, plastic member, or glass member that serves as a unitary fascia member for the user interface 1000. Suitable materials for manufacturing the cover layer 1001 include clear or translucent plastic film, such as 0.4 millimeter, clear polycarbonate film. In another embodiment, the cover layer 1001 is manufactured from a thin sheet of reinforced glass. The cover layer 1001 may include printing or graphics.

The capacitive sensor layer 1002 is disposed below the cover layer 1001. The capacitive sensor layer 1002, which can be formed by depositing small capacitive plate electrodes on a substrate, is configured to detect the presence of an object, such as a user's finger, near to or touching the user interface 1000 control circuitry, such as processor (901) or driver (908), detects a change in the capacitance of a particular plate combination on the capacitive sensor layer 1002. The capacitive sensor layer 1002 may be used in a general mode, for instance to detect the general proximate position of an object, such as when detecting initial contact. Alternatively, the capacitive sensor layer 1002 may also be used in a specific mode, such as when determining displacement, where a particular capacitor plate pair may be detected to detect the location of an object along length and width of the user interface 1000.

A high-resolution display 1003 can be placed beneath the capacitive sensor layer. The high-resolution display 1003, such as a pixilated liquid crystal display, can be used to present data—and alter the data presentation thereon—as described herein.

A resistive switch layer 1004 may optionally be included for detecting contact with the user interface 1000. Resistive switches can serve as a force switch array configured to detect contact. When contact is made with the user interface 1000, impedance changes of any of the switches may be detected. The array of switches may be any of resistance sensing switches, membrane switches, force-sensing switches such as piezoelectric switches, or other equivalent types of technology.

A substrate layer 1005 can be provided to carry the various control circuits and drivers for the layers of the display. The substrate layer 1005, which may be either a rigid layer such as FR4 printed wiring board or a flexible layer such as copper traces printed on a flexible material such as Kapton®, can include electrical components, integrated circuits, processors, and associated circuitry to control the operation of the display.

To provide tactile feedback, an optional tactile feedback layer 1006 may be included. The tactile feedback layer 1006 may include a transducer configured to provide a sensory feedback when a switch on the resistive switch layer 1004 or capacitive sensor layer 1002 detects contact with the user interface 1000. In one embodiment, the transducer is a piezoelectric transducer configured to apply a mechanical “pop” to the user interface 1000 that is strong enough to be detected by the user.

Turning now to FIG. 11, illustrated therein is an alternate electronic device 1100 suitable for use with embodiments of the invention. FIG. 11 is included because many embodiments of the invention described above have included touch-sensitive displays. However, as noted above, embodiments of the invention are not so limited. In the illustrative embodiment of FIG. 11, the user interface includes a display 1101 for presenting information to a user, a keypad 1102, and a slider bar 1103. The keypad 1102 and slider bar 1103 are configured to receive tactile input from a user.

The user may employ the slider bar 1103 to effect scrolling or data presentation alteration. The slider bar 1103 may be configured as a touch sensitive pressure pad, or it may be configured as a non-touch sensitive mechanical device such as a lever or mechanically sliding switch.

Where the slider bar 1103 is configured as a touch sensitive pressure pad for example, a user may place a finger at the center 1104 of the slider bar 1103 initially, and may slide the finger up or down to scroll data accordingly. Where the slider bar is configured as a lever for example, a user may contact the lever in a neutral position initially, and may deflect the lever a certain amount for a certain amount of time to scroll data as well. Methods and apparatuses within the electronic device 1100 can then determine displacement and contact duration, and accordingly velocity and overshoot, as previously described herein.

Turning to FIG. 12, illustrated therein is an alternate embodiment of an electronic device suitable for use with embodiments of the invention. As noted above, embodiments of the present invention are not limited to touch sensitive user interfaces. Embodiments of the present invention can also be used with non-touch sensitive user interfaces such as mouse devices, infrared pointers, joysticks, pressure pads, and the like. FIG. 12 illustrates one such embodiment where an electronic device 1200 includes a joystick.

In the illustrative embodiment of FIG. 12, the joystick 1201 is actuated by the user by placing a finger 1204 on an interface 1202 the joystick 1201 and deflecting the interface 1202 by a certain deflection 1205 from a neutral position 1203. Rather than determining contact with a touch sensitive screen as described above, the initial user contact is detected the moment 1206 the joystick 1201 is deflected from the neutral position 1203. A duration time 1207 can then be measured as the amount of time during which the joystick 1201 is deflected from the neutral position 1203.

In accordance with embodiments of the invention, a control circuit executes code comprising one or more routines stored in the memory to alter the presentation of data 1208 by causing the data 1208 to scroll along the display 1209 in accordance with a velocity determined from a velocity curve and based upon the displacement 1205. As such, the farther the user moves the finger 1204 to deflect the joystick 1201 from the neutral position 1203, the faster the data 1208 scrolls.

Once the joystick 1201 is returned to the neutral position 1203, the scrolling process stops. In one embodiment, it is stopped based upon two factors—the amount of time 1207 the finger 1204 was deflecting the joystick 1201, and the velocity at which the data 1208 was scrolling when the joystick 1201 was returned to the neutral position 1203 as described above.

Similarly, turning now to FIG. 13, embodiments of the invention can be used with other non-touch sensitive devices. In FIG. 13, the non-touch sensitive device is a mouse 1301. The mouse 1301 is actuated when the user clicks a button on the mouse, as is indicated by point 1302. The mouse 1301 can then be deflected by moving the mouse 1301 along a surface, which results in a net deflection 1303 from the position the mouse 1301 was in when the button was clicked. A duration time 1304 can then be measured as the amount of time during which the button is held down by the user.

In accordance with embodiments of the invention, a control circuit executes code comprising one or more routines stored in the memory to alter the presentation of data 1305 by causing the data 1305 to scroll along the display 1306 of a computer 1307 in accordance with a velocity determined from a velocity curve and based upon the displacement 1303. As such, the farther the user moves the mouse 1301 while depressing the button, the faster the data 1305 scrolls.

Once the mouse button is released, as indicated at point 1308, the scrolling process stops. In one embodiment, it is stopped based upon two factors—the amount of time 1304 the mouse button was depressed, and the velocity at which the data 1305 was scrolling when mouse button was released, as described above. From the illustrative examples of FIGS. 12 and 13, it will be clear to those of ordinary skill in the art having the benefit of this disclosure that any number of control devices where the actuation and duration of actuation can be determined are suitable for the methods described herein.

Embodiments of the present invention as described above offer a variety of advantages over prior art scrolling techniques. For example, as described herein embodiments of the invention employ the displacement or distance between the two locations to determine rate of scrolling or other data presentation alteration. This velocity can be equally determined regardless of the absolute position of a user's finger or stylus on a display.

Next, embodiments of this invention are capable of delivering multiple “modes” or perceived behaviors through the use of multiple velocity or overshoot tables stored in memory. For example, as described above a first mode can be “rate scrolling” where the rate is determined by the deflection. This mode is entered when a finger or pointing device touches the user interface and moves thereon to a different location while maintaining contact. If contact with the user interface is lost, a second mode occurs.

As described above, in one embodiment the second mode is a deceleration mode or overshoot mode. Depending on how long the finger has been in continuous contact with the user interface, the deceleration or overshoot can occur in different ways as directed by a plurality of overshoot curves. For short contact durations, scrolling can decelerate fast enough to only allow one or two data elements to pass. If the contact duration is medium length, a second overshoot table can cause the deceleration to appear ballistic, thereby allowing for a natural, slow deceleration. This mode enables a “flick” experience to be achieved.

If the contact duration is longer, the third overshoot table can cause deceleration fast enough to only allow perhaps one screen's worth of data to pass before coming to a complete stop. This mode allows for very fast scrolling speeds but very small overshoot when the user releases their finger.

Finally, a third mode is achieved when the scrolling is in mode one and the deflection passes a certain absolute magnitude for a certain amount of time (both these values are configurable). In this mode, the scrolling can transition from “smooth” scrolling to “step” scrolling. In smooth scrolling, the list of data elements can be scrolled in a way that every part of the list will at some point in time be displayed, even if it is for a very small duration. In step scrolling, the list can move to the given location, ignoring all content in between the starting and ending point.

Next, embodiments of the present invention do not require multiple “touches” of the user interface. As described above, there need only be a single touch. After the first touch, the position of the finger or pointing device can be continually monitored. The rate of scrolling or data presentation alteration can then be correspondingly changed and updated based on the deflection. This velocity can be dynamic and non-linear.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for altering presentation of data on a user interface of an electronic device, comprising:
altering presentation of the data in accordance with a velocity selected from predetermined velocity data, the velocity being selected based upon a displacement traversed by an object along the user interface; and
ceasing the altering in accordance with a deceleration factor selected from predetermined deceleration data, the deceleration factor being selected based upon a contact duration during which the object is in contact with the user interface and a data alteration velocity occurring at a time the object ceases contact with the user interface.

2. The method of claim 1, wherein the user interface comprises a touch sensitive display, further wherein at least one of the predetermined velocity data or the predetermined deceleration data is stored in a memory of the electronic device.

3. The method of claim 1, wherein the predetermined velocity data comprises a velocity curve depending from a displacement magnitude, the velocity curve comprising a plurality of predetermined velocities each being associated with a corresponding displacement magnitude.

4. The method of claim 3, wherein the velocity curve is non-linear.

5. The method of claim 3, further comprising changing the altering as the displacement changes.

6. The method of claim 1, wherein the predetermined deceleration data comprises a plurality of overshoot curves, each overshoot curve comprising a plurality of data overshoot quantities each being associated with a corresponding velocity.

7. The method of claim 6, wherein each of the plurality of overshoot curves is associated with a different predetermined contact duration window, wherein the deceleration factor is selected from an overshoot curve corresponding to a contact duration window spanning the contact duration.

8. The method of claim 6, wherein the predetermined deceleration data comprises a maximum overshoot value, wherein once the contact duration exceeds a predetermined contact duration limit, the deceleration factor is set to the maximum overshoot value.

9. The method of claim 6, wherein at least one overshoot curve is non-linear.

10. The method of claim 1, wherein one of the velocity selected or the deceleration factor selected is further based upon an amount of data to be displayed in a list.

11. The method of claim 1, wherein one of the velocity selected or the deceleration factor selected is further based on a size of a display of the electronic device.

12. The method of claim 1, wherein the altering comprises one of scrolling a list of the data or discretely stepping through the list of the data.

13. A circuit for use in altering a presentation of data on a display in an electronic device, the circuit comprising:
a displacement detector configured to determine a displacement traversed by an object along a user interface of the electronic device;
a velocity selector configured to select a velocity based upon the displacement from predetermined velocity data stored in a memory of the electronic device, and to cause a driver to alter the presentation of the data on the display in accordance with the velocity;
a duration detector configured to determine a duration during which the object is in contact with the user interface; and
an overshoot selector configured to select an overshoot quantity of data elements to display upon the object ceasing contact with the user interface based upon the duration and the velocity from a plurality of overshoot curves stored in the memory, and to cause the driver to cease alteration of the presentation in accordance with the overshoot quantity of data elements.

14. The circuit of claim 13, wherein the predetermined velocity data comprises a maximum data alteration presentation velocity, wherein when the displacement corresponds to the maximum data alteration presentation velocity, the velocity selector is configured to cause the driver to alter the presentation of the data by discretely stepping through the data.

15. The circuit of claim 13, wherein the plurality of overshoot curves comprise a maximum overshoot value, wherein the maximum overshoot value is equivalent to a number of data elements that can be presented on the display in a single presentation.

16. A portable electronic device having a display and a user interface, comprising:
a control circuit;
a memory, accessible by the control circuit and containing instructions executable by the control circuit and configured to cause the control circuit to:
scroll data on the display in accordance with a velocity determined from a velocity curve and based upon a displacement traversed by an object along the user interface; and
cease scrolling in accordance with an overshoot factor determined from one or more overshoot curves and based upon a contact duration during which the object is in contact with the user interface and a scroll velocity occurring at a time the object ceases contact with the user interface.

17. The portable electronic device of claim 16, wherein the one or more overshoot curves comprise at least a first overshoot curve corresponding to the object contacting the user interface for less than a first predetermined duration and a second overshoot curve corresponding to the object contacting the user interface for at least the first predetermined duration.

18. The portable electronic device of claim 17, wherein the one or more overshoot curves comprise at least a third overshoot curve corresponding to the object contacting the user interface for at least a second predetermined duration.

19. The portable electronic device of claim 18, wherein the velocity curve is non-linear and comprises a predetermined velocity maximum, further wherein the third overshoot curve has a predetermined overshoot maximum.

20. The portable electronic device of claim 16, wherein the display and the user interface are comprised in a touch sensitive display.
